(19) United States
(12) Patent Application Publication
(10) Pub. No.: US 2016/0364735 A1
(43) Pub. Date: Dec. 15, 2016

(54) Cross-Platform Mobile Application Reporting System

(71) Applicant: App Annie Inc., San Francisco, CA (US)

(72) Inventors: Nicholas Ian McIntosh, Oakland, CA (US); Jie Teng, Beijing (CN); Kristin Kazue Yamauchi, San Francisco, CA (US); Isabelle Fanchiu Engler, Millbrae, CA (US); Mark Wilson Ungerer, San Francisco, CA (US); Matthew James Hunter, San Francisco, CA (US); Bertrand Schmitt, San Francisco, CA (US)

(21) Appl. No.: 14/740,140

(22) Filed: Jun. 15, 2015

(51) Int. Cl. G06Q 30/02; H04L 29/08

(52) U.S. Cl. CPC G06Q 30/0201; H04L 67/30

(57) ABSTRACT

A cross-platform mobile application reporting system is disclosed that generates analytical reports for a business entity sorted on an aggregated business metric. The reporting system receives a set of application properties for one or more mobile applications from a plurality of application stores. The reporting system extracts metadata about a plurality of publisher profiles from the application properties and clusters two or more of the plurality of publisher profiles based on a determined likelihood that the clustered publisher profiles represent the same business entity. The clustered publisher profiles and their mobile applications are associated with a business entity. The business metric for the mobile applications associated with the business entity is aggregated and an analysis report is generated based in part on the aggregated business metric. The report is sent, responsive to the request, for display to a user.

### BACKGROUND

This invention relates generally to the field of analytics for mobile applications, and in particular to linking publisher accounts by a common company and linking companies with its subsidiary entities and reporting analytics related to the mobile applications for linked publishers or companies across multiple platforms.

The mobile application industry is huge, and there are millions of applications in a handful of mobile application stores that are developed by business entities or by individuals. An application publisher is a business entity or an individual that is listed in a mobile application store as the provider of the application. The publisher provides information about itself to the application store when submitting the application to the application store. The information that the publisher provides about itself is stored as an online publisher profile and allows a publisher to submit multiple applications from the same publisher profile. Due in part to this self-reporting, many applications that are actually provided by the same company are listed as being provided by different publishers that may have one or more publisher profiles. Moreover, an application publisher for various reasons, may choose to publish applications in separate, but essentially similar publisher accounts. An application publisher may be acquired by another business entity, thus changing the parent company that is providing the mobile application. It may be useful for a business entity, investor, or an application developer to review and analyze a certain business metric related to mobile applications (e.g., revenue, downloads, application franchise, etc.) to make decisions for their own businesses or application development. The metric may be useful to be provided across all the available application platforms indicated by the mobile application stores and broken down by company, publisher, and location, among other dimensions.

### SUMMARY

A cross-platform mobile application reporting system generates an analysis report that provides one or more business metrics for the mobile applications aggregated by publisher and/or company associated with the publishers of the applications. The business metrics may include any statistics for a mobile application that may be useful for review, such as total revenue for the application, total downloads of the application, total daily users of the application, etc. The reports may be sorted by the business metric, thereby providing a listing of the top companies for each metric. Moreover, the reports may be generated across all platforms and mobile application stores (e.g., Google Play, iOS, Windows, and Amazon) to provide a single window into the overall performance of a company's mobile applications.

To generate the report, in one embodiment, the cross-platform analysis reporting system receives a set of application properties from all the mobile application stores. The application properties include a publisher for the application. A set of applications that have the same publisher are linked to each other. Similarly, multiple publishers are linked together based on likelihood that they represent the same business entity. This likelihood is determined by comparing information about the publishers obtained from the application stores and/or other external sources. The linking of publishers may be completely automatic, or it may be suggested to a human operator who can confirm or reject the link between publishers. Linked publishers are associated with a company, or business entity.

By linking publishers to a company, the applications provided any of the publishers that are linked to the company are themselves linked transitively. Once the mobile applications of multiple publishers are linked to various business entities, an application analysis report can be generated that aggregates a business metric by each company. In one example, the system obtains the business metric for each mobile application associated with each business entity. The system then aggregates the applications' metrics by company to obtain an aggregated metric for the companies. An application analysis report is then prepared by listing the companies' metrics and sorting the listing by the business metric.

### BRIEF DESCRIPTION OF THE DRAWINGS

FIG. 1 is a block diagram illustrating a computing environment for cross-platform reporting system for mobile applications according to one embodiment.

FIG. 2 is a block diagram illustrating logical components of a cross-platform reporting system for mobile applications according to one embodiment.

FIG. 3 is a flow diagram illustrating a method for cross-platform application analytics reporting for a mobile application according to one embodiment.

FIG. 4 is a diagram showing an example of a set of relationships among applications, publishers, and a business entity.

FIG. 5 is an example of a page that shows a business entity along with its list of publishers and subsidiaries, according to one embodiment.

FIG. 6 is an exemplary report illustrating top companies across one or more application stores sorted based on downloads and revenue for mobile applications according to one embodiment.

The figures depict various embodiments of the present invention for purposes of illustration only. One skilled in the art will readily recognize from the following discussion that alternative embodiments of the structures and methods illustrated herein may be employed without departing from the principles of the invention described herein.

### DETAILED DESCRIPTION

### Overview

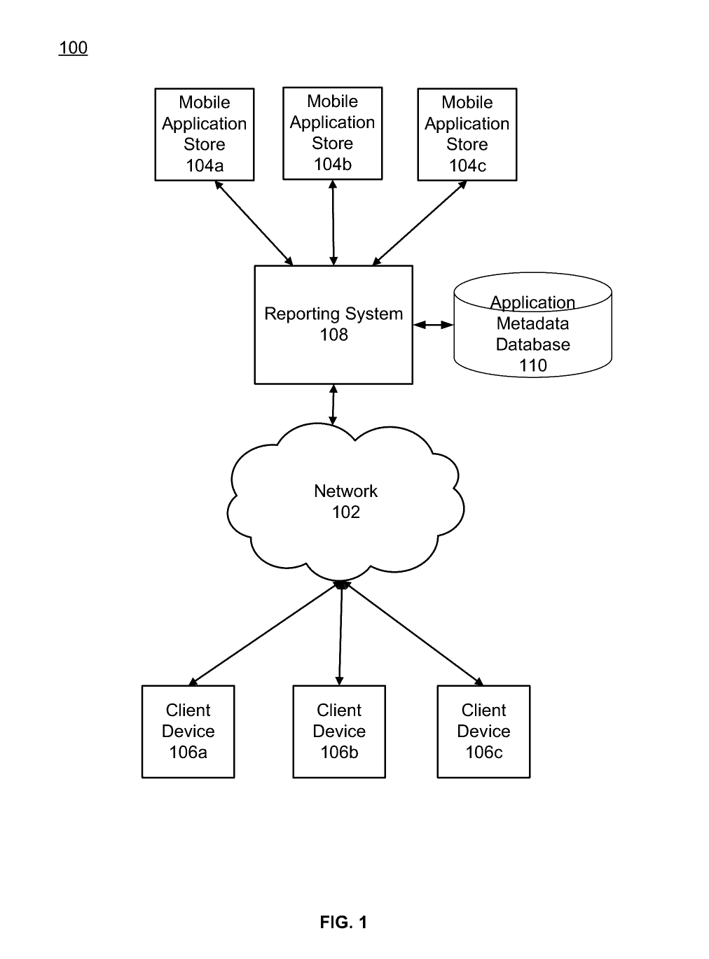

FIG. 1 is a block diagram illustrating a computing environment for a cross-platform mobile application reporting system according to one embodiment of the present disclosure. The computing environment 100 shown by FIG. 1 comprises one or more client devices 106, a network 102, one or more mobile application stores 104 and a cross-platform mobile application reporting system 108. In alternative configurations, different and/or additional components may be included in the system environment 100.

The client devices 106 are one or more computing devices capable of receiving user input as well as transmitting and/or receiving data via the network 102. In one embodiment, a client device 106 is a smartphone, a tablet or a conventional computer system, such as a desktop or laptop computer. Alternatively, a client device 106 may be a device having computer functionality that accesses a set of mobile applications. A client device 106 is configured to communicate via the network 102. In one embodiment, a client device 106 executes an application allowing a user of the client device 106 to interact with the reporting system 108. For example, a client device 106 executes a browser application to enable interaction between the client device 106 and the reporting system 108 via the network 102. In another embodiment, a client device 106 interacts with the reporting system 108 through an application programming interface (API) running on a native operating system of the client device 106, such as IOS® or ANDROID™.

The client devices 106 are configured to communicate via the network 102, which may comprise any combination of local area and/or wide area networks, using both wired and/or wireless communication systems. In one embodiment, the network 102 uses standard communications technologies and/or protocols. For example, the network 102 includes communication links using technologies such as Ethernet, 802.11, worldwide interoperability for microwave access (WiMAX), 3G, 4G, code division multiple access (CDMA), digital subscriber line (DSL), etc. Examples of networking protocols used for communicating via the network 102 include multiprotocol label switching (MPLS), transmission control protocol/Internet protocol (TCP/IP), hypertext transport protocol (HTTP), simple mail transfer protocol (SMTP), and file transfer protocol (FTP). Data exchanged over the network 120 may be represented using any suitable format, such as hypertext markup language (HTML) or extensible markup language (XML). In some embodiments, all or some of the communication links of the network 102 may be encrypted using any suitable technique or techniques.

One or more mobile application stores 104 may be coupled to the reporting system 108, which provides analytical reports for a business entity that may provide multiple applications through one or more of the stores 104. A mobile application store 104 includes downloadable mobile applications and a set of metadata for each mobile application. Among this metadata, a mobile application developer provides a set of application properties, such as the publisher of an application, the title, the country that the application was developed in, and other information about the application. This information is stored in the mobile application store 104, and at least some of it is exposed to users when the application is published for download by the users.

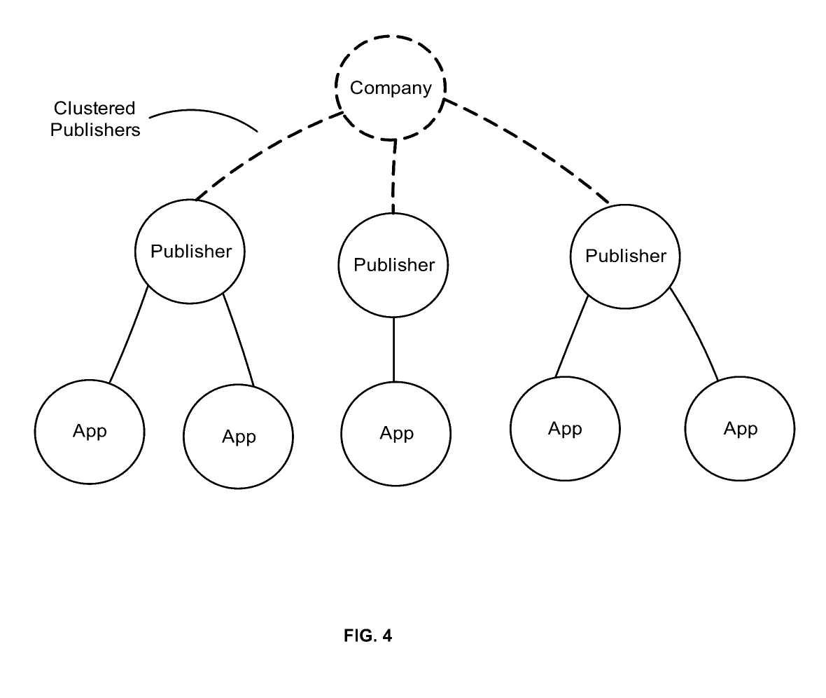

The reporting system 108 downloads information about the mobile applications available on each of the mobile application stores 104. The downloaded information includes information about a publisher of the application and one or more business metrics for the application on the mobile application store 104. The business metric may be any metric useful for reporting, as described herein. Using this information, the reporting system 108 associates multiple publishers with business entities (as described below in connection with FIG. 4) and then generates an analytics report listing on one or more business metrics aggregated by business entity. The business metric listed in the analytics report may be aggregated for each business entity across multiple mobile applications stores 104.

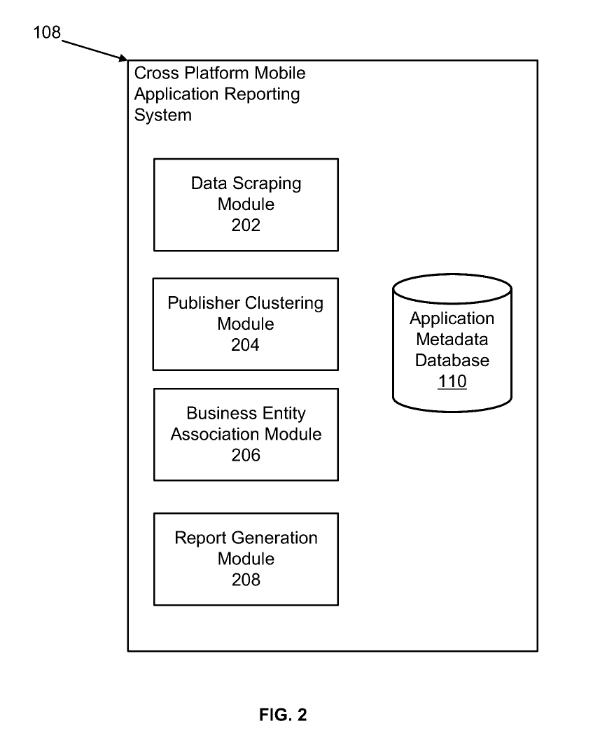

FIG. 2 is a block diagram illustrating the logical components of the reporting system 108 for mobile applications according to one embodiment. The logical components include a data scraping module 202, a publisher clustering module 204, business entity association module 206, a report generation module 208 and the application metadata database 110.

The data scraping module 202 receives a set of application properties for each of the mobile application in the store from one or more application stores and scrapes for metadata related to each of the mobile application. The metadata can be scraped, for example, by crawling through the pages accessible to the public or through APIs that are open for public use, in the application store. In another embodiment, the reporting system may be able to obtain the metadata information by signing up as a trusted partner of the application stores, and obtaining the metadata through APIs for trusted partners from the application stores.

The application store may update the properties periodically, or add additional properties. For example, once the application is published, the application store may add additional properties for an application, such as the number of downloads for the application, the country of downloads, the revenue generated by the application, any user-provided reviews and comments about the application, and any other information generated after the application is made available in the store. The data scraping module 202 may scrape the application properties periodically or may request to receive the application properties at a specific time, and then scrape the data from the application properties (e.g., upon receiving a request from a user to generate a report for a specific business metric).

The data scraping module 202 sends over the scraped data to the publisher clustering module 204 that links a publisher profile to another publisher profile to form clusters of publisher profiles. The mobile application to the publisher profile is directly extracted from the scraped data. All the mobile applications that have the same publisher profile are linked together. For example, a “Facebook” mobile application from the iOS Store is linked to the “Facebook” application from the Android store based on the same publisher profile.

The publisher clustering module 204 receives scraped data from the data scraping module 202 for a publisher profile and the publisher profiles are matched with each other, to form clusters of publisher profiles. The publisher profiles may be clustered based on a set of rules, such as matching the name of the publisher, address of the publisher, URLs of the publishers and other such data. The publishers may be matched on one of the rules or a combination of one or more rules.

For example, the set of rules to apply for matching may include, matching the publisher name and the publisher address. Each of the rules may include a weightage, i.e. two publisher profiles may be clustered, if the publisher name matches 90% and the publisher address matches 100%, or any configured value for a match (e.g., 90%).

A second set of rules for matching may include matching the publisher name and a publisher parent name. A third set of rules may include matching the publisher profile name to one of the publisher profile names that belongs to an existing cluster. Similarly, other rules may be established based on the publisher profile data to determine the clustering of the publisher profiles. The publisher profiles may be related based on similar names across different application stores, similar names across different geographical regions, or similar business entity addresses. This secondary data for matching may be incorporated in the set of rules for clustering. For example, a set of publishers may have different properties across different platforms and countries but actually represent the same publisher in real life. For example, a publisher “Starbucks Coffee Company” and another publisher “Starbucks Coffee Company Korea” may both represent the same company “Starbucks,” which simply created different publisher entities to provide mobile applications to the application stores in different countries (e.g., U.S and Korea). These publisher profiles are identified and clustered together.

Once the publisher profiles are clustered, the business entity association module 206 either associates a publisher profile to an existing business entity or creates a new business entity formed by the clustered publishers. If the clustered publishers do not belong to a business entity, a new business entity is created either automatically or manually, and is stored in the application metadata database 110. If one of the publisher profiles is associated with a business entity, and the others are not, the other publisher profiles in the cluster are added to the business entity associated with the publisher profile. If one of the publisher profiles is associated with a first business entity and another publisher profile is associated with a second business entity, the business entities are merged and the clustered publisher profiles are associated with the merged business entity.

The publisher profiles are clustered based on a set of rules determined by the metadata of the publisher profiles, and the clustered publisher profiles are used to create or associate with business entities. In addition to the clustered publisher profiles, business entities may be created based on events such as a change in a business entity and publisher relationship, for example merger or acquisition of a business entity associated with a publisher profile. These events are retrieved from the application metadata database 110 and are used along with the clustered publisher profiles to either form new business entities or to change association of publisher profile to a business entity.

For example, the publisher “Nest labs” and “Waze” are two separate publisher profiles that generally will not be clustered together, based on their scraped data. In particular, none of the application properties (such as the title, description, version, or category) match when compared to each other, but the business entity and publisher relationship for both the publishers has a common relationship (i.e., both were acquired by same business entity, “Google Inc.”). Since the two publishers are linked to a common parent company, a common business entity for the publishers of the two mobile applications is established.

The report generation module 208 receives requests for generating an analysis report for a business entity or a set of business entities based on a business metric. The mobile application report generation module 208 retrieves from the application metadata database 110 a list of publishers and mobile applications associated with a business entity. Based on the list of mobile applications related to a business entity, the aggregated business metric (e.g., the total number of application downloads for a business entity is calculated as the sum of the application downloads of each mobile application associated with the business entity) is calculated for each business entity. The business entities are sorted based on the aggregated business metric and a report is generated for it.

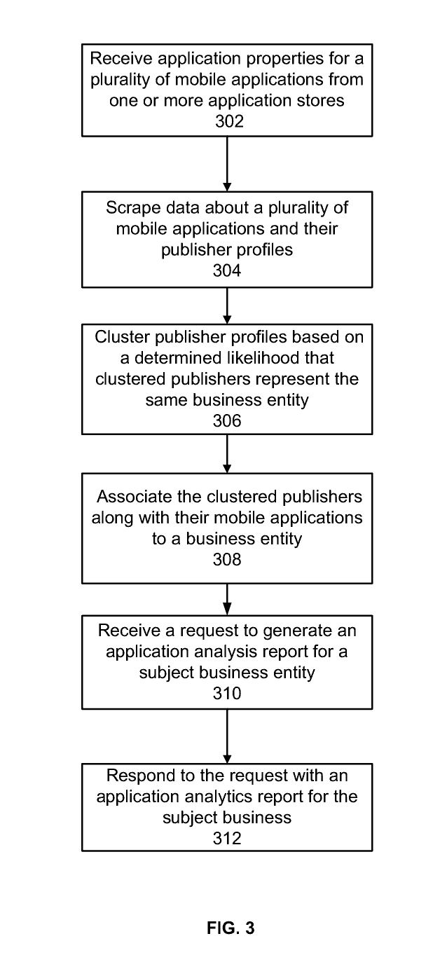

FIG. 3 is a flow diagram illustrating a method for cross-platform application analytics reporting for a mobile application according to one embodiment. The reporting system 108 receives 302 application properties for one or more mobile applications from one or more application stores. On receiving the application properties, the reporting system 108 scrapes 304 data related to the mobile applications and their publisher profiles. The scraped data may include title of the application, version, URL, publisher profile, etc., and the publisher profile data may include name of the publisher, address of the publisher, URL, etc. Based on the scraped data, a likelihood is determined that two publisher profiles represent the same business entity, and the publisher profiles are clustered 306 according to the determined likelihood.

To perform the clustering of publishers, the reporting system 108 obtains a set of application properties for each mobile application in the store 104 from one or more application stores. The reporting system 108 clusters multiple publishers based on various techniques. For example, two or more mobile applications that have the same publisher name are linked together. The metadata for the publishers is extracted from the application properties, metadata for a publisher may include a business entity name that owns the publisher, geographical location of a publisher, device id for the publisher of the application, the URL submitted by a publisher of an application, the application name of the applications published by the publisher profile, the application icon of the applications published by the publisher profile, the URL of the application and other such information. Based on the extracted metadata for each publisher, two or more publishers are clustered together based on the likelihood that they belong to the same business entity, for example, rules such as overlapping text in the name of the publisher, same name of the application but provided in a different geographical region and other such heuristics. For example, each element value of the metadata of a first publisher may be matched with the corresponding element value of the metadata of other publishers stored in the application metadata database 110. If a 100% match or any configured value for a match (e.g., 90%) is found for all the elements of the metadata of a publisher, the two publishers may be clustered together as belonging to the same business entity.

The clustered publisher profiles along with their mobile applications are either associated 308 with an existing business entity or a new business entity is created that represents the clustered publisher profiles, as shown and described below with respect to FIG. 4. This may take into consideration events such as merger and acquisitions of business entities that include one or more publisher profiles and one or more mobile applications associated with it. For example, if there is not already a business entity associated with any of the publishers being clustered, a new business entity is created and the publishers are associated with it. If there is a, or by adding one or more publishers to an existing business entity, i.e. in case a publisher matches another publisher that is associated with a business entity.

At some point, the reporting system receives 310 a request to generate an application analysis report for a subject business entity, for example, a report showing the top 10 business entities sorted by the number of downloads, or a report showing the revenue of “Google Inc.” based on downloads of its mobile applications. To prepare such a report, the reporting system 108 obtains the aggregated metric (e.g. revenue) for the subject business entity by determining the publishers (e.g. Nest, Google Labs, etc.) associated with the business entity, identifying the mobile applications (Google Mail, Nest, Dropcam, etc.) for those publishers, and aggregating the metric (revenue for each subsidiary or mobile application) associated with the mobile applications, thereby determining an aggregated metric for the entire business entity. The generated report is sent by the reporting system in response 312 to the request for the application analysis report.

FIG. 4 is an example of associating mobile applications to publishers, and linking clustered publishers to a business entity, according to one embodiment. As shown in the figure, one or more mobile applications are linked to a publisher profile based on a direct link between them that is retrieved from the application properties of the mobile application. The publishers that have a likelihood of belonging to the same business entity are clustered and are linked together to form a new business entity, according to one embodiment. The link from the clustered publishers to the new business entity is shown by dotted lines. In another embodiment, a publisher may be linked into an existing business entity, if the publisher profile matches one of the publisher profiles that are already linked to the business entity.

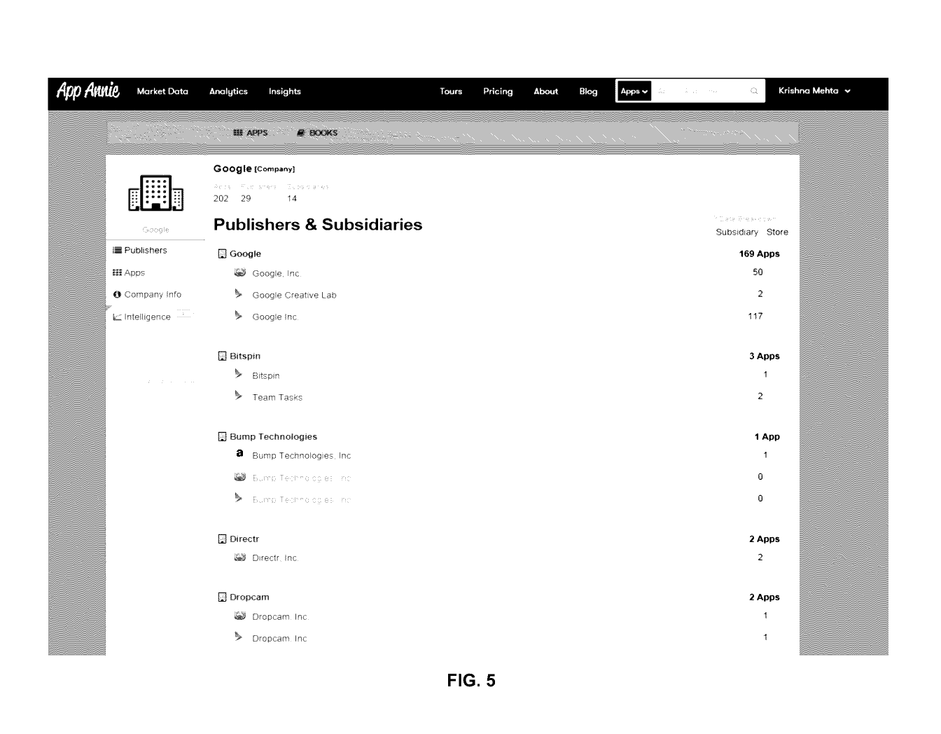

FIG. 5 is an example of a page that shows a business entity along with its list of publishers and subsidiaries, according to one embodiment. As shown in the figure, the business entity “Google” includes a total of 202 mobile applications, 29 publishers and 14 subsidiaries. For example, a mobile application Dropcam, Inc. in the Google Play store is linked to the unified application and publisher titled “Dropcam” and the publisher “Dropcam” is linked along with the other publishers to a common parent company Google.

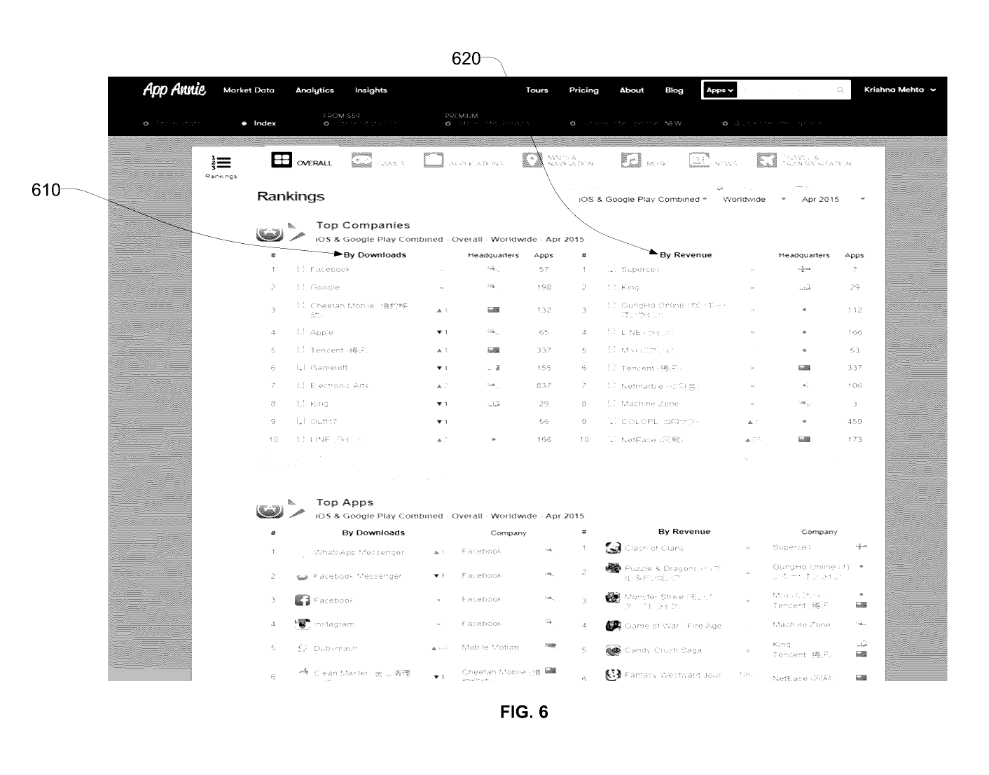

FIG. 6 is an exemplary report illustrating top companies across one or more application stores sorted based on downloads 610 and revenue 620 for mobile applications according to one embodiment. The report includes a list of top ten companies across the iOS Store and Google Play sorted by the number of application downloads for the business entity. Another section of the report includes a list of top ten companies across the iOS Store and Google Play sorted by the revenue earned from the mobile applications of the business entity. The report has been generated worldwide for April 2015. These parameters are customizable, and a user can request for report generation for any previous month and year, or for a specific country, or across just one of the application stores, or by any other dimension supported by the analytics system. Additionally, the reports can be grouped based on categories, such as games, maps/navigation, or music.

### SUMMARY

The foregoing description of the embodiments of the invention has been presented for the purpose of illustration; it is not intended to be exhaustive or to limit the invention to the precise forms disclosed. Persons skilled in the relevant art can appreciate that many modifications and variations are possible in light of the above disclosure.

Some portions of this description describe the embodiments of the invention in terms of algorithms and symbolic representations of operations on information. These algorithmic descriptions and representations are commonly used by those skilled in the data processing arts to convey the substance of their work effectively to others skilled in the art. These operations, while described functionally, computationally, or logically, are understood to be implemented by computer programs or equivalent electrical circuits, microcode, or the like. Furthermore, it has also proven convenient at times, to refer to these arrangements of operations as modules, without loss of generality. The described operations and their associated modules may be embodied in software, firmware, hardware, or any combinations thereof.

Any of the steps, operations, or processes described herein may be performed or implemented with one or more hardware or software modules, alone or in combination with other devices. In one embodiment, a software module is implemented with a computer program product comprising a computer-readable medium containing computer program code, which can be executed by a computer processor for performing any or all of the steps, operations, or processes described.

Embodiments of the invention may also relate to an apparatus for performing the operations herein. This apparatus may be specially constructed for the required purposes, and/or it may comprise a general-purpose computing device selectively activated or reconfigured by a computer program stored in the computer. Such a computer program may be stored in a non-transitory, tangible computer readable storage medium, or any type of media suitable for storing electronic instructions, which may be coupled to a computer system bus. Furthermore, any computing systems referred to in the specification may include a single processor or may be architectures employing multiple processor designs for increased computing capability.

Embodiments of the invention may also relate to a product that is produced by a computing process described herein. Such a product may comprise information resulting from a computing process, where the information is stored on a non-transitory, tangible computer readable storage medium and may include any embodiment of a computer program product or other data combination described herein.

Finally, the language used in the specification has been principally selected for readability and instructional purposes, and it may not have been selected to delineate or circumscribe the inventive subject matter. It is therefore intended that the scope of the invention be limited not by this detailed description, but rather by any claims that issue on an application based hereon. Accordingly, the disclosure of the embodiments of the invention is intended to be illustrative, but not limiting, of the scope of the invention, which is set forth in the following claims.

What is claimed is:

1. A method for cross-platform reporting for mobile applications, the method comprising:
receiving a set of application properties for a plurality of mobile applications from a plurality of application stores, the application properties for a mobile application including a publisher profile of the mobile application;
extracting metadata about a plurality of publisher profiles from the received application properties;
clustering two or more of the plurality of publisher profiles based on a determined likelihood that the clustered publisher profiles represent the same business entity;
associating each of the mobile applications that has a publisher profile of the clustered publishers with the business entity;
receiving a request to generate an application analysis report across the plurality of application stores for the business entity;
aggregating a business metric for the mobile applications associated with the business entity;
generating the application analysis report based in part on the aggregated business metric; and
sending, responsive to the request, the generated application analysis report for display to a user.

2. The method of claim 1, wherein a plurality of mobile applications are linked into groups such that each mobile application in the group has the same publisher profile.

3. The method of claim 1, wherein the application properties further include a country of publication.

4. The method of claim 1, wherein the metadata of a publisher profile includes a URL of the business entity represented by the publisher.

5. The method of claim 1, wherein clustering publisher profiles includes comparing metadata of a first publisher profile to the metadata of a second publisher profile to determine a match.

6. The method of claim 1, wherein determining a likelihood that the clustered publisher profiles represent a business entity further comprises of determining a relationship between a publisher profile and a business entity.

7. The method of claim 1, wherein an aggregating a business metric for a business entity includes calculating a sum of the business metric of each of the mobile applications associated with the business entity.

8. A computer program product for cross-platform reporting for mobile applications, the computer program product comprising a computer-readable storage medium containing computer program code for:
receiving a set of application properties for a plurality of mobile applications from a plurality of application stores, the application properties for a mobile application including a publisher profile of the mobile application;
extracting metadata about a plurality of publisher profiles from the received application properties;
clustering two or more of the plurality of publisher profiles based on a determined likelihood that the clustered publisher profiles represent the same business entity;
associating each of the mobile applications that has a publisher profile of the clustered publishers with the business entity;
receiving a request to generate an application analysis report across the plurality of application stores for the business entity;
aggregating a business metric for the mobile applications associated with the business entity;
generating the application analysis report based in part on the aggregated business metric; and
sending, responsive to the request, the generated application analysis report for display to a user.

9. The computer program product of claim 8, wherein a plurality of mobile applications are linked into groups such that each mobile application in the group has the same publisher profile.

10. The computer program product of claim 8, wherein the application properties further include a country of publication.

11. The computer program product of claim 8, wherein the metadata of a publisher profile includes a URL of the business entity represented by the publisher.

12. The computer program product of claim 8, wherein clustering publisher profiles includes comparing metadata of a first publisher profile to the metadata of a second publisher profile to determine a match.

13. The computer program product of claim 8, wherein determining a likelihood that the clustered publisher profiles represent a business entity further comprises of determining a relationship between a publisher profile and a business entity.

14. The computer program product of claim 8, wherein an aggregating a business metric for a business entity includes calculating a sum of the business metric of each of the mobile applications associated with the business entity.

15. A computer program product for cross-platform reporting for mobile applications, the computer program product comprising a computer-readable storage medium containing computer program code that comprises:
a reporting system module that receives set of application properties for a plurality of mobile applications from a plurality of application stores, the application properties for a mobile application including a publisher profile of the mobile application;
a data scraping module, that extracts metadata about a plurality of publisher profiles from the received application properties;
a publisher clustering module that clusters two or more of the plurality of publisher profiles based on a determined likelihood that the clustered publisher profiles represent the same business entity;
a business entity association module, that associates each of the mobile applications that has a publisher profile of the clustered publishers with the business entity; and
a report generating module, that receives a request to generate an application analysis report across the plurality of application stores for the business entity, and
sends, responsive to the request, a generated application analysis report for display to a user.

16. The computer program product of claim 15, wherein the report generating module aggregates a business metric for the mobile applications associated with the business entity.

17. The computer program product of claim 16, wherein the report generating module generates the application analysis report based in part on the aggregated business metric.
